(19) United States
(12) Patent Application Publication
(10) Pub. No.: US 2007/0253184 A1
(43) Pub. Date: Nov. 1, 2007

(54) Lighting device for outdoor use

(75) Inventor: Ariberto Tamborini, Daverio (Varese) (IT)

Correspondence Address: HEDMAN & COSTIGAN P.C., 1185 AVENUE OF THE AMERICAS, NEW YORK, NY, 10036, US

(73) Assignee: MERLETT TECNOPLASTIC S.P.A

(21) Appl. No.: 11/521,948

(22) Filed: Sep. 15, 2006

(30) Foreign Application Priority Data
Apr. 28, 2006 (IT) MI2006U000154

(51) Int. Cl. F21V 9/16

(52) U.S. Cl. 362/84

(57) ABSTRACT

An improved lighting device for outdoor use comprises a lamp body, made of a polymeric material or other synthetic resin, and including a plurality of light emitting or phosphorescent material inserts.

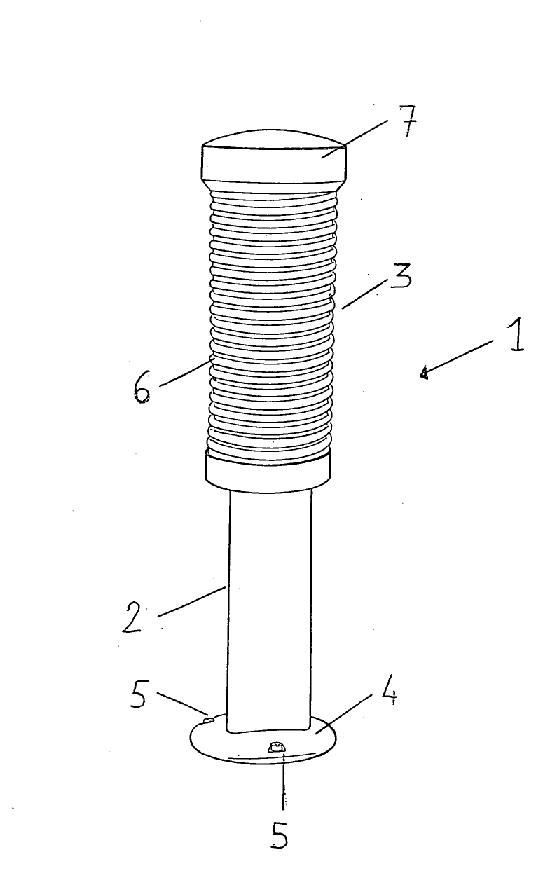

### BACKGROUND OF THE INVENTION

The present invention relates to an improved lighting device, specifically designed for outdoor applications, and having improved operating characteristics.

As is known, lamps or illuminating devices in general used in outdoor applications, must be very strong, reliable in operation, and resistant against water and dirt; moreover, they must have a pleasant aesthetic aspect.

Prior outdoor illuminating devices provide to use lamps or Chinese lanterns made of polymeric materials, adapted to meet the above mentioned operating requirements, with a comparatively low making cost.

### SUMMARY OF THE INVENTION

The aim of the present invention is to provide an improved lighting device, specifically but not exclusively adapted to be used in outdoor applications, which has improved operating and functional characteristics with respect to like prior lighting devices.

Within the scope of the above mentioned aim, a main object of the invention is to provide such a lighting device which can be easily made by using commercially available materials and elements.

Yet another object of the invention is to provide such a lighting device which is very inexpensive and has very good aesthetic characteristics.

According to one aspect of the present invention, the above mentioned aim and objects, as well as yet other objects, which will become more apparent hereinafter, are achieved by a lighting device construction, for outdoor uses, characterized in that said lighting device comprises a lamp body including a coil tube made of a polymeric or other synthetic resin material, of a type used for making fluid conveying tubes, and including a plurality of light emitting or phosphorescent inserts therein.

### BRIEF DESCRIPTION OF THE DRAWING

Further characteristics and advantages of the present invention will become more apparent hereinafter from the following detailed disclosure of a preferred, though not exclusive, embodiment of the invention, which is illustrated, by way of an indicative, but not limitative example, in the accompanying drawing, the sole FIGURE of which is a perspective view of the subject lamp or lighting device construction which has been improved according to the invention.

### DESCRIPTION OF THE PREFERRED EMBODIMENT

With reference to the number references of the above mentioned FIGURE, the lighting device or lamp construction according to the invention, which has been generally indicated by the reference number 1, comprises a supporting element 2, adapted to support a lamp body 3 and including a bearing base or bottom 4.

Said bearing base or bottom 4 may comprise clamping means for clamping the lighting device to a floor or the ground, said clamping means comprising, for example, a plurality of clamping bolts 5.

According to the invention, the lamp body 3 comprises a coil tube 6, made of a polymeric material, or other synthetic resin, of a type used for making fluid conveying tubes or pipes.

More specifically, said tube 6 comprises a main construction encompassing a coil or spiral member.

Said main construction or structure is preferably, though not exclusively, made of a plasticized polyvinylchloride (PVC) material, whereas the spiral or coil member can be made of a thermoplastic polymer, such as a rigid PVC.

Said tube may be coated on its outside by an anti-abrasion coating layer, made of a polyurethane or other plastics material of like characteristics, and it can be lined in its inside by a like lining layer which, advantageously, can be further coated by a disposable layer, which would be very useful for facilitating the making of the device by known prior making means.

According to the invention, the light emitting or phosphorescent material is preferably, though not exclusively, co-extruded with the spiral or coil member.

In particular, said light emitting or phosphorescent material can be provided, for example, in a film form, or as a thermoplastic polymeric material co-extruded with the spiral member.

Thus, the tube can be made by hot extruding a strip member which, as encompassed on a pulling mandrel, will form, at the end of a cooling step, the desired tube.

The extruding is performed by an extruding head, of a per se known type, supplied by a plurality of extruders, each of which will form that portion of the strip contributing to making one of the tube elements or members.

Finally, the pulling mandrel, by a plurality of rollers, will adjust the inclination of the strip, so as to cause the strip turns to be fed along said mandrel, thereby they are sealed onto one another to form the desired tube.

Thus, the formed tube will be ready for use, at the end of the winding and cooling operating steps.

As shown, the lamp body 3 is closed, and the top thereof, by a cover member 7, preventing water and dirt from entering the lamp body.

The present invention provides moreover, in lamps of any desired type and configuration, the application of structural elements including light emitting or phosphorescent substances, allowing to easily detect in dark the lamps, even in a switched off condition thereof.

It has been found that the invention fully achieves the intended aim and objects.

In fact, the invention provides a lighting device construction which can be made starting from easily commercially available elements and materials and which comprises a plurality of light emitting or phosphorescent material inserts therein, thereby, even if power supply is switched off, the device will be visible and, according to requirements, adapted to illuminate for a time the encompassing area.

The post-switching off illuminating effect can be used both for an ornamental purpose or for a functional one.

In practicing the invention, the used materials, and the contingent size and shapes, can be any, depending on requirements.

1. A lighting device, specifically designed for outdoor applications, characterized in that said lighting device comprises a lamp body, made of a polymeric or other synthetic resin material, and including a plurality of light emitting or phosphorescent material inserts therein.

2. A lighting device, according to claim 1, characterized in that said lighting device comprises a lamp body including a coiled tube, of a type used for liquid conveying tubes.

3. A lighting device, according to claim 1, characterized in that said lighting device comprises a supporting element adapted to support said lamp body and including a bearing bottom.

4. A lighting device, according to claim 1, characterized in that said bearing bottom comprises clamping means for clamping said bearing bottom to a floor.

5. A lighting device, according to claim 1, characterized in that said coiled tube comprises a main structure encompassing a spiral member.

6. A lighting device, according to claim 1, characterized in that said main structure is made of a plasticized polyvinylchloride (PVC) material, and said spiral member is made of a thermoplastic polymer, such as a rigid PVC.

7. A lighting device, according to claim 1, characterized in that said light emitting or phosphorescent material is preferably, though not exclusively, co-extruded with said spiral member.

8. A lighting device, according to claim 1, characterized in that said light emitting or phosphorescent material can be provided in a thermoplastic polymer film form, co-extruded on a hollow element.

9. A lighting device, according to claim 1, characterized in that said lamp body is closed, at the top thereof, by a closing cover preventing water and dirt from entering the lamp body.

10. A lighting device, according to claim 1, characterized in that said lighting device is adapted to be used in illuminating lamps of any desired type and configuration, and that said light emitting or phosphorescent inserts are adapted to allow said lighting device to be detected in a dark condition, even if the lighting device is in a switched-off condition.
